(19) United States
(12) Patent Application Publication
(10) Pub. No.: US 2026/0277826 A1
(43) Pub. Date: Sep. 17, 2026

(54) CONTROL DEVICE

(71) Applicants: KABUSHIKI KAISHA TOSHIBA, Kawasaki-shi (JP); Toshiba Electronic Devices & Storage Corporation, Kawasaki-shi (JP)

(72) Inventors: Yoshimitsu Shimojo, Kawasaki Kanagawa (JP); Yosuke Matsushita, Tokyo (JP); Tsuyoshi Sekine, Yokohama Kanagawa (JP)

(21) Appl. No.: 19/305,015

(22) Filed: Aug. 20, 2025

(30) Foreign Application Priority Data
Mar. 17, 2025 (JP) 2025-042766

(51) Int. Cl. G06F 12/14; G06F 21/12

(52) U.S. Cl. CPC G06F 12/1458; G06F 12/1441; G06F 21/121; G06F 2212/1052

(57) ABSTRACT

A control device includes a central processing unit, a nonvolatile memory, and a volatile memory. The control device is configured to first enter a first state after activation, and enter a second state after the first state, set an address range in the volatile memory that the central processing unit is inhibited from accessing in each state, and, when first entering the first state after activation, execute a program stored in the nonvolatile memory while the central processing unit is inhibited from accessing all areas in the volatile memory.

### CROSS-REFERENCE TO RELATED APPLICATIONS

This application is based upon and claims the benefit of priority from Japanese Patent Application No. 2025-042766, filed Mar. 17, 2025, the entire contents of which are incorporated herein by reference.

### FIELD

Embodiments described herein relate generally to a control device.

### BACKGROUND

There are known control devices that control mechanical components and/or electric circuits in devices. Such a control device includes a microcontroller. The microcontroller operates according to a program stored in a storage device. The microcontroller may have a secure state to achieve high security of the device.

### BRIEF DESCRIPTION OF THE DRAWINGS

FIG. 1 illustrates components of a device including a control device according to a first embodiment and connections among the components.

FIG. 2 illustrates hardware components and connections of the control device according to the first embodiment.

FIG. 3 illustrates a storage area in a nonvolatile memory of the control device according to the first embodiment.

FIG. 4 illustrates a storage area in a RAM of the control device according to the first embodiment.

FIG. 5 illustrates hardware components of a CPU of the control device according to the first embodiment.

FIG. 6 illustrates a bus access monitoring circuit of the control device according to the first embodiment.

FIG. 7 illustrates transitions of the state of the control device according to the first embodiment.

FIG. 8 illustrates classification of sub areas in the storage area in the nonvolatile memory of the control device according to the first embodiment.

FIG. 9 illustrates classification of sub areas in the storage area in the RAM of the control device according to the first embodiment.

FIG. 10 illustrates an example of a specification for accessibility and inaccessibility realized by the bus access monitoring circuit of the control device according to the first embodiment.

FIG. 11 conceptually illustrates an example operation of the control device according to the first embodiment.

FIG. 12 illustrates classification of sub areas in a storage area in a nonvolatile memory of a control device according to a second embodiment.

FIG. 13 conceptually illustrates a state and an operation of the control device according to the second embodiment.

### DETAILED DESCRIPTION

In general, according to one embodiment, a control device includes a central processing unit, a nonvolatile memory, and a volatile memory. The control device is configured to first enter a first state after activation, and enter a second state after the first state, set an address range in the volatile memory that the central processing unit is inhibited from accessing in each state, and, when first entering the first state after activation, execute a program stored in the nonvolatile memory while the central processing unit is inhibited from accessing all areas in the volatile memory.

Embodiments will now be described with reference to the figures. In order to distinguish components having substantially the same function and configuration in an embodiment or over different embodiments from each other, an additional numeral or letter may be added to the end of each reference numeral or letter. In the following description, in an embodiment following an embodiment that is already described, different points from the already described embodiment are mainly described. The entire description of a particular embodiment applies to another embodiment unless an explicit mention is made otherwise, or an obvious elimination is involved.

### 1. First Embodiment

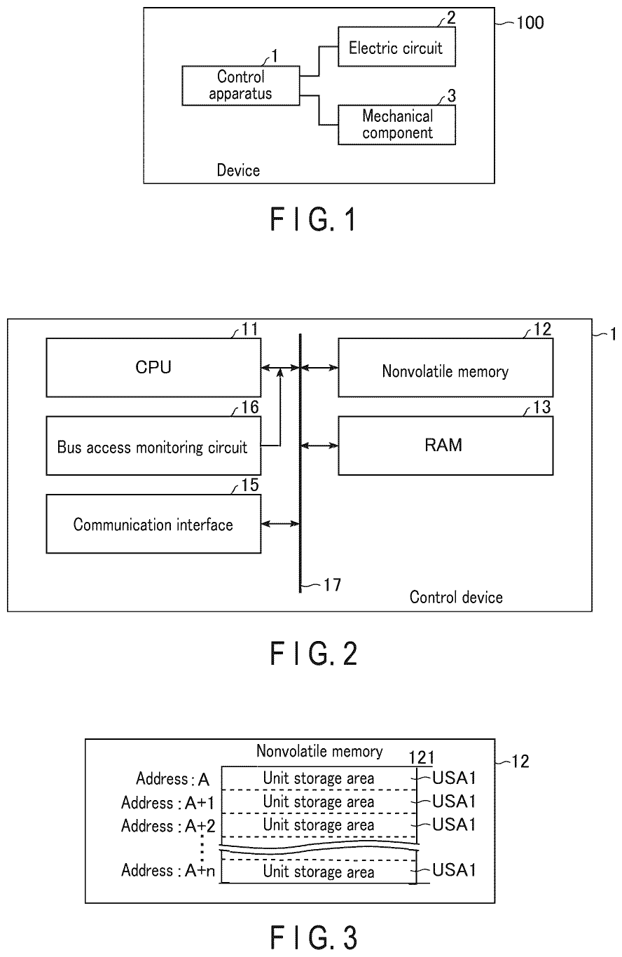

FIG. 1 illustrates components of a device including a control device according to a first embodiment and connections among the components. As illustrated in FIG. 1, a device 100 includes a control device 1, an electric circuit 2, and a mechanical component 3. Examples of the device 100 include home appliances.

The electric circuit 2 is a circuit for implementing an operation based on a function provided by the device 100.

The mechanical component 3 includes a structure and a movable component for implementing an operation based on a function provided by the device 100.

The control device 1 controls the electric circuit 2 and the mechanical component 3. Examples of the control device 1 include a microcontroller. In one example, the control device 1 has a form of a semiconductor chip.

FIG. 2 illustrates hardware components and connections of the control device according to the first embodiment. As illustrated in FIG. 2, the control device 1 includes a central processing unit (CPU) 11, a nonvolatile memory 12, a random access memory (RAM) 13, a communication interface 15, a bus access monitoring circuit 16, and a bus 17.

The CPU 11 operates based on a program stored in the nonvolatile memory 12. The CPU 11 has a flash patch function to be described later.

The nonvolatile memory 12 is a memory that stores data in a nonvolatile manner. The nonvolatile memory 12 stores a program for causing the CPU 11 to perform a certain operation. The nonvolatile memory 12 also stores data necessary for the operation of the control device 1. Examples of the nonvolatile memory 12 include a flash memory.

The RAM 13 is a volatile memory, and is a memory that continues to store data while the RAM 13 is supplied with power. The RAM 13 stores data necessary for the operation of the control device 1 while the control device 1, or the RAM 13, is supplied with power. The RAM 13 also functions as a work area for the CPU 11. Examples of the RAM 13 include a static random access memory (SRAM).

The communication interface 15 is an interface for the control device 1 to communicate with external components. Examples of the external components include the electric circuit 2 and the mechanical component 3. The communication interface 15 is connected to the external components by interconnects for allowing communication by a system with which the control device 1 and the external components communicating with the control device 1 are compliant. Examples of the communication interface 15 include a universal asynchronous receiver/transmitter (UART), an inter integrated circuit (I2C), and a serial peripheral interface (SPI).

The CPU 11, the nonvolatile memory 12, the RAM 13, and the communication interface 15 are connected to one another by the bus 17.

The bus access monitoring circuit 16 is a circuit that monitors and controls access to the bus 17 by a bus master. The bus master is a CPU or a direct memory access (DMA) controller, for example, but the bus access monitoring circuit 16 is described with a CPU taken as an example herein. The bus access monitoring circuit 16 is connected to the CPU 11, the bus 17, and/or the interconnect connecting the CPU 11 and the bus 17 so that communication between the CPU 11 and the bus 17 can be monitored. In one example, the bus access monitoring circuit 16 is connected to an input/output terminal of the CPU 11, and is configured to be able to interpret a signal output from the CPU 11.

In one example, the bus access monitoring circuit 16 can interpret address information in an access request (to read data, to write data, or to read an instruction to be executed) from the CPU 11 to the nonvolatile memory 12.

In one example, the bus access monitoring circuit 16 can interpret address information in an access request (to read data, to write data, or to read an instruction to be executed) from the CPU 11 to the RAM 13.

FIG. 3 illustrates a storage area in the nonvolatile memory of the control device according to the first embodiment. As illustrated in FIG. 3, the nonvolatile memory 12 includes a storage area (or a storage space) 121. The storage area 121 includes a plurality of unit storage areas USA1. Each unit storage area USA1 has a fixed size that can be of any size equal to or larger than 1 bit, and is assigned a unique address. In other words, the unit storage areas USA1 are portions of the storage area 121 to which unique addresses are assigned. In FIG. 3, a value A used as an example of an address can be any number.

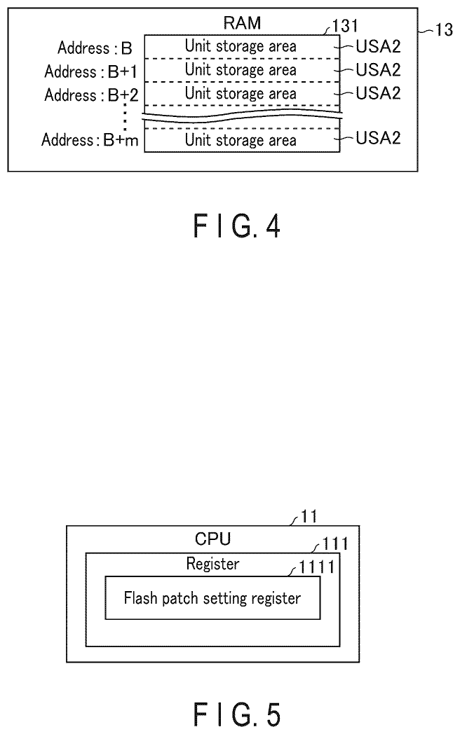

FIG. 4 illustrates a storage area in the RAM of the control device according to the first embodiment. As illustrated in FIG. 4, the RAM 13 includes a storage area (or a storage space) 131. The storage area 131 includes a plurality of unit storage areas USA2. Each unit storage area USA2 ha fixed size that can be of any size equal to or larger than 1 bit, and is assigned a unique address. In other words, the unit storage areas USA2 are portions of the storage area 131 to which unique addresses are assigned. In FIG. 4, a value B used as an example of an address can be any number, and differs from the value A.

FIG. 5 illustrates hardware components of the CPU of the control device according to the first embodiment. As illustrated in FIG. 5, the CPU 11 includes a register 111. The register 111 includes a flash patch setting register 1111.

The flash patch setting register 1111 holds the addresses to be used in the flash patch function. The flash patch function is a function of the CPU 11 as described above, and is an address remapping function. More specifically, the flash patch function is a function of causing the CPU 11 to access one or more unit storage areas USA2 of some address(es) in the RAM 13 instead, in a case where a program for controlling the CPU 11 instructs the CPU 11 to access one or more unit storage areas USA1 of some address(es) in the nonvolatile memory 12 (or, immediately before the program executes a code for an instruction for access to one or more unit storage areas USA1 of some address(es) in the nonvolatile memory 12). The addresses to be remapped in the nonvolatile memory 12 are associated with the addresses to be accessed by remapping in the RAM 13, by the flash patch setting register 1111 on a one-to-one basis. Specifically, the flash patch setting register 1111 holds the addresses to be remapped in the nonvolatile memory 12, and the addresses to be accessed by remapping in the RAM 13.

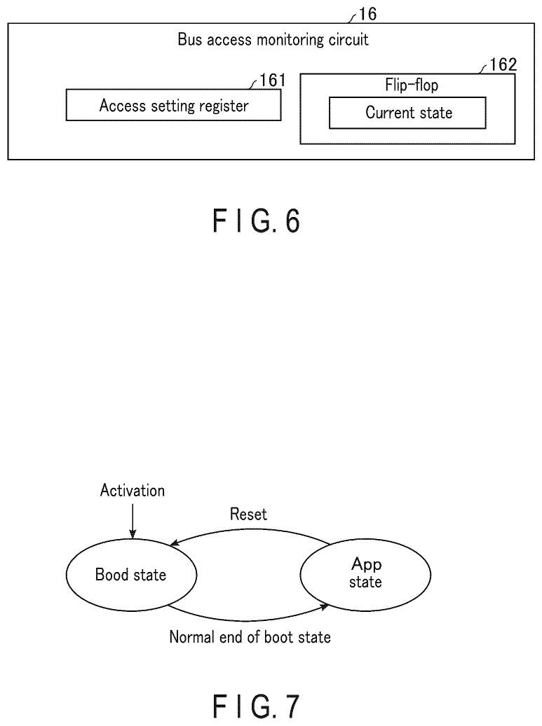

FIG. 6 illustrates hardware components of the bus access monitoring circuit 16 of the control device according to the first embodiment. As illustrated in FIG. 6, the bus access monitoring circuit 16 includes an access setting register 161 and a flip-flop 162 indicating a current state. In one example, the value held by the flip-flop 162 indicates a boot state when it is 0, and indicates an App state when it is 1. The value 1 may indicate a boot state, and the value 0 may indicate an App state. The flip-flop 162 may be configured to be regarded as a register by the CPU 11 so that the current state can be checked from a program being executed by the CPU 11.

The access setting register 161 of the bus access monitoring circuit 16 holds information indicating the range of addresses accessible (or inaccessible) for the bus master in the nonvolatile memory 12 and the RAM 13 in each state. In a case where a condition that access by the bus master is not allowed is satisfied, the bus access monitoring circuit 16 instructs the control device 1 to reset.

FIG. 7 illustrates transitions of the state of the control device according to the first embodiment. The bus access monitoring circuit 16 monitors whether a state transition condition is satisfied, and, based on the result of the monitoring, updates the current state. As illustrated in FIG. 7, the control device 1 can enter at least a boot state and an App state. The boot state is a secure state for executing a program for startup, and is the state that the control device 1 first enters after activated or reset. The App state is a normal state in which a program for an application is executed, and is a state to be entered after a normal end of the boot state.

In the boot state, the control device 1 performs settings on the hardware of the control device 1, and a preparation process for the processing to be performed in the App state. In one example, in the boot state, the control device 1 performs settings on the hardware of the control device 1, and a preparation process for the processing to be performed in the App state, according to a program stored in the nonvolatile memory 12. Examples of operations to be performed by the control device 1 in the boot state include a check as to whether the programs and data in the nonvolatile memory 12 have been falsified in an unauthorized manner, a calculation of a key for encrypted communication to be performed between the control device 1 and an external device, and a check as to whether unauthorized software is likely to run. After the operation performed in the boot state comes to an end in a normal manner, the control device 1 transitions to the App state.

In the App state, the control device 1 executes various functions required to be executed by the control device 1. In one example, the control device 1 in the App state performs various operations for controlling the electric circuit 2 and the mechanical component 3 so as to implement the functions that are provided by the device 100.

The control device 1 in the App state transitions to the boot state by resetting. The resetting includes resetting that occurs because the bus access monitoring circuit 16 detects a condition for inaccessibility in the App state.

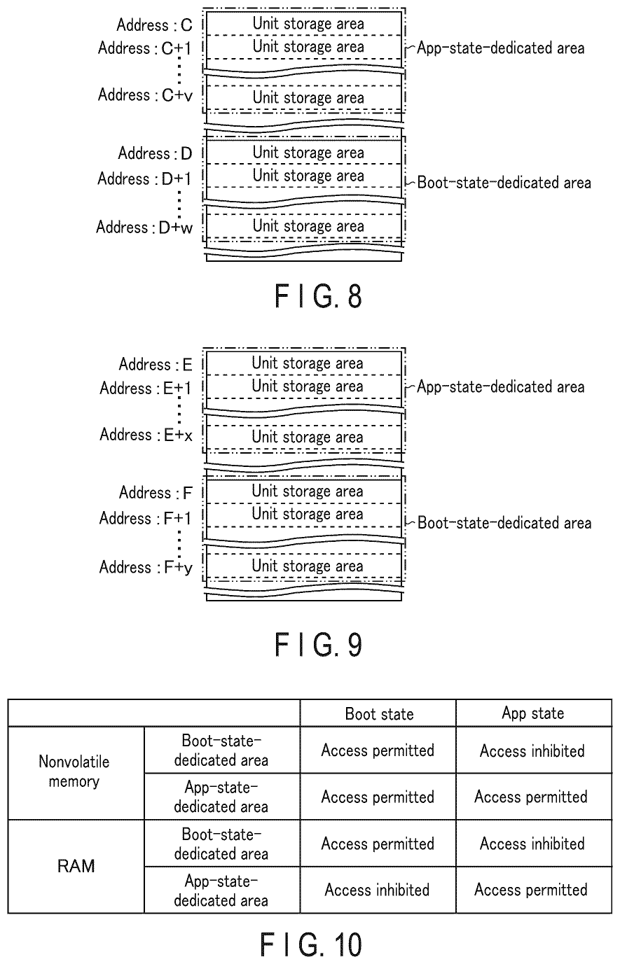

FIG. 8 illustrates classification of sub areas in the storage area in the nonvolatile memory of the control device according to the first embodiment. As illustrated in FIG. 8, an App-state-dedicated area and a boot-state-dedicated area as sub areas are defined in the storage area 121.

The App-state-dedicated area in the nonvolatile memory 12 stores a program for causing the CPU 11 to execute a function and/or processing to be performed by the CPU 11 in the App state of the control device 1. Hereinafter, the program for causing the CPU 11 to execute a function and/or processing to be performed by the CPU 11 in the App state of the control device 1 may be collectively referred to as an App state execution program. In FIG. 8, values C and v used as an example of addresses can be any numbers.

The boot-state-dedicated area in the nonvolatile memory 12 stores a program for causing the CPU 11 to execute a function and/or processing to be performed by the CPU 11 in the boot state of the control device 1. Hereinafter, the program for causing the CPU 11 to execute a function and/or processing to be performed by the CPU 11 in the boot state of the control device 1 may be collectively referred to as a boot state execution program. In one example, the boot-state-dedicated area in the nonvolatile memory 12 stores a key to be used by the control device 1 in encrypted communication with the outside, and a key calculation program.

FIG. 9 illustrates classification of sub areas in the storage area in the RAM of the control device according to the first embodiment. As illustrated in FIG. 9, an App-state-dedicated area and a boot-state-dedicated area as sub areas are defined in the storage area 131. Specific addresses of these sub areas are configured to be changeable by a boot state program.

FIG. 10 illustrates an example of a specification for accessibility and inaccessibility realized by the bus access monitoring circuit of the control device according to the first embodiment. FIG. 10 illustrates whether the CPU 11 can access the sub areas in the nonvolatile memory 12 and the RAM 13 in each state. The access setting register 161 of the bus access monitoring circuit 16 holds the ranges of addresses of the boot-state-dedicated areas and the App-state-dedicated areas in the nonvolatile memory 12 and the RAM 13. The CPU 11 is configured to be able to change the ranges of addresses of the boot-state-dedicated area and the App-state-dedicated area in the RAM 13 by rewriting the values in the access setting register in the boot state. In one example, the control device 1 is configured so that access by the CPU 11 is permitted or inhibited for each combination of a state and a sub area as illustrated in FIG. 10.

Note that access to the nonvolatile memory 12 and the RAM 13 by the CPU 11 specifically includes the three types: read, write, and execution. Even if permission or inhibition is individually defined for each of read, write, and execution, the effectiveness of the present embodiment does not change.

The control device 1 is configured so that the CPU 11 can access the boot-state-dedicated area in the nonvolatile memory 12 while the control device 1 is in the boot state.

The control device 1 is configured so that the CPU 11 can access the App-state-dedicated area in the nonvolatile memory 12 while the control device 1 is in the boot state.

The control device 1 is configured so that the CPU 11 can access the boot-state-dedicated area in the RAM 13 while the control device 1 is in the boot state.

The control device 1 is configured so that the CPU 11 cannot access the App-state-dedicated area in the RAM 13 while the control device 1 is in the boot state.

The control device 1 is configured so that the CPU 11 cannot access the boot-state-dedicated area in the nonvolatile memory 12 while the control device 1 is in the App state.

The control device 1 is configured so that the CPU 11 can access the App-state-dedicated area in the nonvolatile memory 12 while the control device 1 is in the App state.

The control device 1 is configured so that the CPU 11 cannot access the boot-state-dedicated area in the RAM 13 while the control device 1 is in the App state.

The control device 1 is configured so that the CPU 11 can access the App-state-dedicated area in the RAM 13 while the control device 1 is in the App state.

The control device 1 is configured so that the CPU 11 cannot access any of the areas in the RAM 13 immediately after the control device 1 transitions to the boot state. This is realized by setting the access setting register 161 of the bus access monitoring circuit 16 so that all the areas in the RAM 13 turn into App-state-dedicated areas immediately after the control device 1 transitions to the boot state, for example. The access setting register 161 of the bus access monitoring circuit 16 is rewritten by the program executed by the CPU 11 in the boot state, and thereby some or all of the areas in the RAM 13 are changed to be a boot-state-dedicated area, so that the boot state program can use the RAM 13.

Accessibility and inaccessibility can be realized by any method. An example of such a method is described below. In the following, a configuration and a method for restricting (or inhibiting) access are described. Access permission is realized by not imposing the access restriction described below.

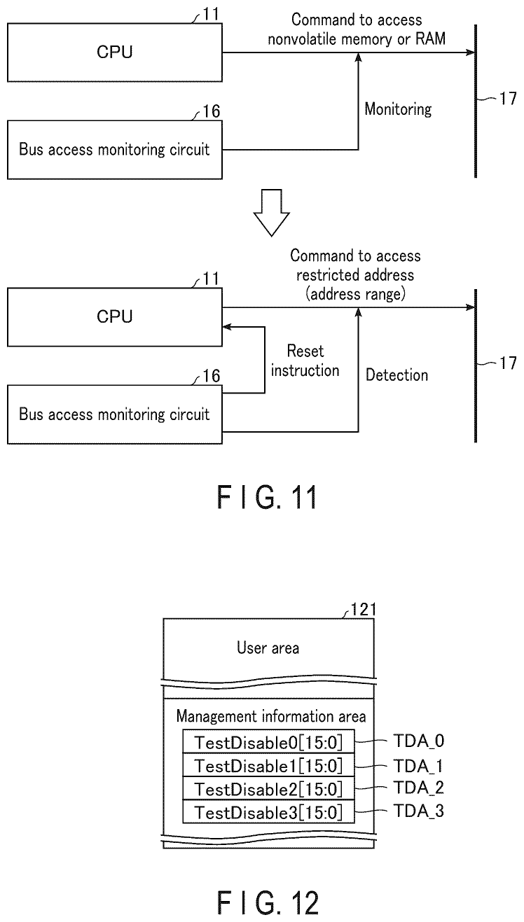

As an example of the access restriction, address information in an access request transmitted from the CPU 11 to the nonvolatile memory 12 and the RAM 13 is used. FIG. 11 conceptually illustrates an example operation of the control device according to the first embodiment. As illustrated in FIG. 11, the bus access monitoring circuit 16 monitors address information in access requests addressed to the nonvolatile memory 12 and the RAM 13 from the CPU 11 via the bus 17. In a case where the address indicated in address information is the address of a sub area to which access is restricted in the current state, the bus access monitoring circuit 16 resets the control device 1, and forcibly suspends the processing according to the program being executed by the CPU 11.

According to the first embodiment, the control device 1 with improved security against unauthorized and unintended operations is provided as described below.

The flash patch function has been developed for the original purpose of achieving a normal operation of the CPU by accessing a substitute program stored in the RAM when a failure or the like occurs in a program in the nonvolatile memory 12. However, wrongful use of the flash patch function is conceivable.

Specifically, a fake key calculation program or a fake key can be stored in the App-state-dedicated area in the RAM, and remapping by the flash patch function can be set so that the fake key calculation program or key can be used in place of the original key calculation program or key. If the control device is restarted in this state, the fake key calculation program or key is used in the boot state. As a result, communication contents are not appropriately encrypted, and communication contents can be decrypted.

Likewise, remapping can be set so that a fake boot state execution program is executed, instead of the original boot state execution program. As a result, a check is not made to determine whether the programs and the data in the nonvolatile memory 12 have been falsified in an unauthorized manner, and therefore, any falsification is not detected even if the programs and the data in the nonvolatile memory 12 have been falsified in an unauthorized manner.

Furthermore, because a fake boot state execution program is executed in place of the original boot state execution program, information not to be decrypted by users can be read from the nonvolatile memory 12.

The control device 1 of the first embodiment is configured so that the CPU 11 cannot access the RAM 13 in the boot state after activation and after reset, and is configured to execute a program stored in the nonvolatile memory 12 in that state. However, the boot state program can change the setting so that the CPU 11 can access the RAM 13 after no possibility of unauthorized software running is confirmed.

As a result, even if the flash patch function is used in an unauthorized manner, the CPU 11 cannot access the RAM 13, and unauthorized use of the flash patch function is prevented.

If the CPU 11 disables the flash patch function in a state in which the CPU 11 cannot access the RAM 13, and then changes the setting so that the CPU 11 can access the RAM 13, the CPU 11 can access the RAM 13 in the subsequent boot state processing.

As an implementation method, in a case where accessibility or inaccessibility is based on FIG. 10 the CPU 11 can be configured so that the CPU 11 cannot access the RAM 13 in the boot state after activation and after reset by setting the entire area in the RAM 13 to the App-state-dedicated area after activation and after reset. The CPU 11 can access the RAM 13 by changing the RAM 13 to the boot-state-dedicated area after the CPU 11 disables the flash patch function.

Note that the present embodiment is not limited to the above method, as long as the CPU 11 cannot access the RAM 13 after activation and after reset. For example, the control device 1 can be configured to accept the change accessibility or inaccessibility to the RAM 13 by changing the setting of a specially prepared register, and be inhibited from accessing the RAM 13 after activation and after reset.

### 2. Second Embodiment

FIG. 12 illustrates classification of storage areas in a nonvolatile memory of a control device according to a second embodiment. As illustrated in FIG. 12, a storage area 121 includes a user area and a management information area. The management information area is an area that stores information necessary for management of a control device 1, and is an area that is not accessed in normal operations including operations of the control device 1 in a boot state and an App state. On the other hand, the user area is an area that is accessed in normal operations of the control device 1, and includes the boot-state-dedicated area and the App-state-dedicated area described in the first embodiment.

The management information area includes two or more test-mode invalidation information areas TDA. FIG. 12 illustrates an example in which there are four test-mode invalidation information areas TDA0, TDA1, TDA2, and TDA3. The following description is based on this example. Each of the test-mode invalidation information areas TDA0, TDA1, TDA2, and TDA3 includes the same number of bits. FIG. 12 illustrates a 16-bit example, and the description below is based on this example.

The same bit string is written into each of the test-mode invalidation information areas TDA0, TDA1, TDA2, and TDA3 to disable the test mode before shipment of the control device 1 or before shipment of the device 100.

A bit string that is the same as an expected bit string is written into each of the test-mode invalidation information areas TDA0, TDA1, TDA2, and TDA3 before shipment of the control device 1 or before shipment of the device 100 as above. As the expected bit string, it is desirable to select a value having a sufficiently low probability of coincidence with an initial value in a state where no values have been written into the test-mode invalidation information areas TDA0, TDA1, TDA2, and TDA3 after the manufacturing of the nonvolatile memory 12. For example, if there is a high possibility that the initial value after the manufacturing of the nonvolatile memory 12 is 0xFFFF . . . , the expected bit string should be selected to have a value different from 0xFFFF . . . . Values are written into the test-mode invalidation information areas TDA after testing of the control device 1.

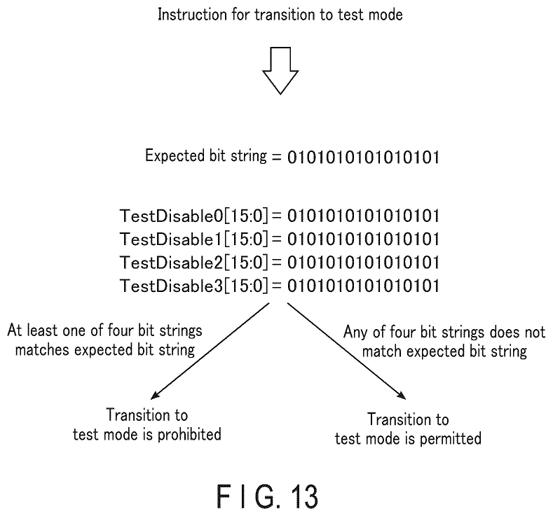

FIG. 13 conceptually illustrates a state and an operation of the control device according to the second embodiment. In a case where a command for instructing the control device 1 to shift to the test mode is received by the control device 1 from the outside, the following operation is performed. Specifically, the control device 1 determines whether any one of the bit strings in the test-mode invalidation information areas TDA0, TDA1, TDA2, and TDA3 matches the expected bit string. The control device 1 is configured not to shift to the test mode in a case where any one of the test-mode invalidation information areas TDA0, TDA1, TDA2, and TDA3 matches the expected bit string.

Also, the control device 1 is configured to shift to the test mode in a case where any of the test-mode invalidation information areas TDA0, TDA1, TDA2, and TDA3 does not match the expected bit string.

According to the second embodiment, a control device in which the test mode is disabled more reliably is provided as described below.

The control device can be brought to the test mode for testing during the manufacture. On the other hand, after shipment, the control device has the test mode disabled so that data stored in the nonvolatile memory is not read or falsified through unauthorized use of the test mode. For that purpose, after the testing at the manufacturing stage, information indicating invalidation of the test mode (test-mode invalidation information) may be stored into the nonvolatile memory. As long as the test mode is disabled, the control device is unable to shift to the test mode. Before the nonvolatile memory is initialized for the first time, the data in the nonvolatile memory is undefined. Therefore, if the area indicating the test-mode invalidation information in the management information area accidentally has a value indicating invalidation of the test mode, the control device cannot be tested at the manufacturing stage, and this control device is handled as a defective product. Further, the bits indicating the test-mode invalidation information might change from the written values due to degradation over time or the like after shipment of the control device. As a result, even though the test mode is disabled immediately after shipment, a state in which the test mode is enabled is unintentionally formed, and therefore, data stored in the nonvolatile memory can be read or falsified with unauthorized use of the test mode.

According to the second embodiment, the management information area includes two or more test-mode invalidation information areas TDA, and a specific identical bit string (expected bit string) is written into each test-mode invalidation information area TDA before shipment of the control device 1. In a case where the bit string in at least one piece of test-mode invalidation information matches the expected bit string, transition to the test mode is inhibited. Since a plurality of bit strings is used, it is possible to suppress invalidation of the test mode from being unintentionally canceled by a change in the bit values after shipment. Furthermore, since matching between a plurality of bit strings and one expected bit string is used as a condition, the test mode is not disabled unless the plurality of bit strings matches the expected values. A plurality of bit strings accidentally coinciding with the expected bit string is unlikely to occur even if the data in the nonvolatile memory is undefined at the manufacturing stage, and therefore, the test mode is prevented from being accidentally disabled before the test. Thus, both unintended invalidation of the test mode at the manufacturing stage and unintended validation of the test mode after shipment are prevented.

The number of test-mode invalidation information areas TDA can be determined based on the following factors. As described above, it is desirable to prevent the test mode from being unintentionally disabled at the manufacturing stage, and to prevent invalidation of the test mode from being unintentionally canceled after shipment of the control device 1 or after shipment of the device 100. The larger the number of bits in the test-mode invalidation information areas TDA, the lower the possibility of unintended invalidation at the manufacturing stage. On the other hand, the larger the number of test-mode invalidation information areas, the lower the possibility of cancellation of invalidation after shipment. Therefore, the number of bits and the number of areas in the test-mode invalidation information areas TDA are determined, with each possibility of prevention of unintended invalidation at the manufacturing stage and unintended cancellation of invalidation after shipment being taken into consideration.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control device comprising:
a central processing unit, a nonvolatile memory, and a volatile memory, wherein
the control device is configured to:
first enter a first state after activation, and enter a second state after the first state,
set an address range in the volatile memory that the central processing unit is inhibited from accessing in each state, and,
when first entering the first state after activation, execute a program stored in the nonvolatile memory while the central processing unit is inhibited from accessing all areas in the volatile memory.

2. The control device according to claim 1, wherein
the control device is configured to change setting to a state in which access to the volatile memory is permitted after the program confirms that there is no possibility that unauthorized software will run in the control device.

3. The control device according to claim 1, wherein
the volatile memory includes a storage area including a first area and a second area,
the control device further comprises:
a bus coupled to the central processing unit, and
a monitoring circuit that
monitors communication between the central processing unit and the bus,
is configured to permit the central processing unit to access the first area of the volatile memory and not to permit the central processing unit to access the second area of the volatile memory while the control device is in the first state,
is configured not to permit the central processing unit to access the first area of the volatile memory but to permit the central processing unit to access the second area of the volatile memory while the control device is in the second state, and
is configured to be able to change address ranges of the first area and the second area according to the program, and
the control device is configured to execute the program stored in the nonvolatile memory in a state in which an entire area of the volatile memory is the second area when the control device first enters the first state after activation, and is configured to be able to change setting of the volatile memory to the first area after the program confirms that there is no possibility that unauthorized software will run.

4. A control device having a first mode,
the control device comprising:
a nonvolatile memory that stores a first bit string including a first number of bits, and a second bit string including the first number of bits; and
a central processing unit that inhibits the control device from transitioning to the first mode in a case where one of a first bit pattern of values stored in the first bit string or a second bit pattern of values stored in the second bit string matches an expected bit pattern, and permits the control device to transition to the first mode in a case where neither the first bit pattern nor the second bit pattern matches the expected bit pattern.

5. The control device according to claim 4, wherein the first mode is a test mode.
